(19) United States
(12) Patent Application Publication
(10) Pub. No.: US 2020/0367343 A1
(43) Pub. Date: Nov. 19, 2020

(54) Multi-Channel Dimmer

(71) Applicant: Siemens Schweiz AG, Zürich (CH)

(72) Inventor: Jakob Reislhuber, Mötzing (DE)

(73) Assignee: Siemens Schweiz AG, Zürich (CH)

(21) Appl. No.: 16/636,986

(22) PCT Filed: Aug. 8, 2018
(86) PCT No.: PCT/EP2018/067906

§ 371 Date: Feb. 6, 2020

(30) Foreign Application Priority Data
Aug. 9, 2017 (DE) 10 2017 213 888.2

(51) Int. Cl. H05B 47/14; H05B 47/185; H05B 47/155

(52) U.S. Cl. CPC H05B 47/14; H05B 45/14; H05B 47/155; H05B 47/185

(57) ABSTRACT

Various embodiments include a dimmer for controlling the power consumption of a connectable load comprising: two dimmer channels with associated channel control facilities; a main control facility producing control commands for the dimmer channels; a communications connection transmitting the control commands from the main control facility to the channel control facility of a dimmer channel; and a channel communications connection transmitting information from the first dimmer channel to the second dimmer channel. The first dimmer channel includes a measuring dimmer channel with a measuring facility configured for producing information regarding the behavior of the electrical voltage at a site in the measuring dimmer channel. The channel communications connection transmits information regarding the behavior of the electrical voltage at the site in the measuring dimmer channel.

### CROSS-REFERENCE TO RELATED APPLICATIONS

This application is a U.S. National Stage Application of International Application No. PCT/EP2018/067906 filed Aug. 8, 2018, which designates the United States of America, and claims priority to DE Application No. 10 2017 213 888.2 filed Aug. 9, 2017, the contents of which are hereby incorporated by reference in their entirety.

### TECHNICAL FIELD

The present disclosure relates to electrical power. Various embodiments may include dimmers for controlling the electrical power consumption of an electrical load, e.g. for an integrated or connectable lighting facility.

### BACKGROUND

Dimmers are used for the purpose of varying electrical power. Such a power variation may be performed by way of leading edge phase control or by way of trailing edge phase control. In the case of leading edge phase control, the current is connected in a delayed manner after the zero crossing of the alternating current and flows until the next current zero crossing. The leading edge phase control is preferred in the case of an inductive load behavior. In the case of trailing edge phase control, conversely the current is immediately connected after the zero crossing and is disconnected again prior to the next zero crossing. This trailing edge phase control is preferred in the case of a capacitive load behavior. In order to produce the control commands that are required for this purpose at the switching components of the dimmer, the dimmer comprises a main control facility.

Multi-channel dimmers comprise multiple individual dimmers that each control a part of the electrical load. These so-called dimmer channels may be connected on the output side in parallel, sequentially or a mixture thereof so as to achieve a power increase. Multiple physical channels are interconnected and a more powerful logic channel is produced. In this case, the dimmer channels may be in a device or however may be in multiple devices.

However, it is important, even owing to this interconnection, that the outputs of the dimmer channels are synchronized to a great extent. If, by way of example, two channels have been connected in parallel and the second channel switches too late (in the case of leading edge phase control) or too early (in the case of trailing edge phase control), the first channel overloads more than if the two synchronously switch incorrectly. This may lead to an excess temperature rise or a failure of the first dimmer channel or even to the dimmer switching off.

In known multi-channel dimmers, each dimmer channel comprises a dedicated channel control facility, e.g. a simple processor, and also a measuring facility for measuring the electrical voltage in the channel, which may also be formed in part even by this processor. Owing to the measuring facility, the channel control facility receives the information regarding the periodic behavior of the electrical voltage in the channel, said information being necessary for the identification of the leading edge or trailing edge. The control commands that are produced by the main control facility are transmitted via each communications connection to the channel control facilities of the dimmer channels and at said channel control facilities are implemented in the channel in accordance with the information regarding the periodic behavior of the electrical voltage in the channel.

In particular, the complexity of the measuring facilities leads to high development costs and production costs. Inaccuracies in the identification of the zero crossing may also occur as a result of component tolerances or as a result of the components aging. The time differences that result therefrom then lead to a non-synchronized switching procedure of the dimmer channels and to the problems described above. Even though it is possible to exchange the device or to recalibrate the components of said device, it is however not possible to do so without incurring costs and possible consequential damage owing to disruptions in operation.

### SUMMARY

The present disclosure includes teachings addressing these disadvantages. For example, in some embodiments of the teachings herein, the main control facility also distributes synchronizing signals to the channel control facilities. These synchronizing signals are based on the information from the measuring facility in an individual dimmer channel, therefore named here as the measuring dimmer channel. It has now been shown however that there is an alternative way with the potential for optimization.

Some embodiments include a dimmer for controlling the power consumption of a connectable load, having at least: two dimmer channels (K1, K2, Kx) each having a channel control facility (S1, S2, Sx), of which dimmer channels (K1, K2, Kx) at least one measuring dimmer channel (K1) comprises a measuring facility (M1) that is at least suitable for producing information regarding the behavior of the electrical voltage at a site in the measuring dimmer channel, a main control facility (HS) that is at least suitable for producing control commands for the dimmer channels, and a communications connection (V) that is at least suitable for transmitting such control commands from the main control facility (H) to the channel control facility (S1) of a dimmer channel (K1), characterized in that the dimmer (D) comprises at least one channel communications connection (V12, V23, V(x−1)x) that is at least suitable for transmitting information from a first dimmer channel (K1, K2) to a second dimmer channel (K2, Kx) and that the channel communications connection (V12, V23, V(x−1)x) is at least suitable for transmitting information regarding the behavior of the electrical voltage at the site in the measuring dimmer channel (K1).

In some embodiments, the channel communications connection (V12, V23, V(x−1)x) is at least suitable for transmitting this information to the channel control facility (S2, Sx) of the second dimmer channel (K2, Kx).

In some embodiments, this information includes a specification regarding the time of at least one zero crossing of the voltage at the site in the measuring dimmer channel (K1).

In some embodiments, the channel control facility (S2, Sx) of the second dimmer channel (K2, Kx) owing to stored data is suitable, with the aid of this information, for producing information regarding the behavior of the electrical voltage at a site in the second dimmer channel (K2, Kx).

In some embodiments, the data includes a time value, which is the same as an estimation of the time for processing and transmitting the information from the measuring dimmer channel (K1) to the control facility of the second dimmer channel (K2, Kx).

In some embodiments, the information regarding the behavior of the electrical voltage at the site in the second dimmer channel (K2, Kx) includes a specification regarding the time of at least one zero crossing of the voltage.

In some embodiments, the channel communications connection (V12, V23, V(x−1)x) is at least also suitable for transmitting control commands from the main control facility (H) from the channel control facility (S1, S2) of the first dimmer channel (K1, K2) to the channel control facility (S2, Sx) of the second dimmer channel (K2, Kx).

In some embodiments, the channel communications connection (V1, V2, V(x−1)x) comprises an element for galvanically separating the first dimmer channel (K1, K2) from the second dimmer channel (K2, Kx).

In some embodiments, the main control facility (H) is a channel control facility.

In some embodiments, the first dimmer channel is different to the measuring dimmer channel (K1).

In some embodiments, at least two channel communications connections are each suitable for transmitting information regarding the behavior of the electrical voltage in the measuring dimmer channel (K1) from the measuring dimmer channel (K1) to at least two other dimmer channels.

### BRIEF DESCRIPTION OF THE DRAWINGS

In the drawings:

FIG. 1 shows the division of functions of a first multichannel dimmer incorporating teachings of the present disclosure on the supply network and a load;

FIG. 2 shows the division of functions of a second multichannel dimmer incorporating teachings of the present disclosure on the supply network and a load; and

FIG. 3 shows with some simplified circuits of two dimmer channels and the channel communications connection between said dimmer channels and channel communications connection of the second multichannel dimmer incorporating teachings of the present disclosure.

### DETAILED DESCRIPTION

In some embodiments, a dimmer incorporating teachings of the present disclosure comprises at least two dimmer channels each having a channel control facility. At least one of the dimmer channels is a measuring dimmer channel because said dimmer channel comprises a measuring facility for measuring the electrical voltage in the channel. The information from said measuring facility regarding the behavior of the electrical voltage in the measuring dimmer channel is transmitted to the channel control facility of the measuring dimmer channel.

In some embodiments, the dimmer further comprises a main control facility, which may at least produce control commands for the dimmer channels, and also a main communications connection that is at least suitable for transmitting such control commands from the main control facility to the channel control facility of a dimmer channel.

In some embodiments, the dimmer further comprises at least one channel communications connection from a first dimmer channel to a second dimmer channel, e.g. having an element for galvanically separating the first dimmer channel from the second dimmer channel, for example having an optical coupler or alternatively having a transformer circuit. This channel communications connection may transmit information, and namely at least regarding the behavior, e.g. the periodic behavior, of the electrical voltage in the measuring dimmer channel from the measuring facility or however from the channel control facility of a first dimmer channel to a second dimmer channel, e.g. to the channel control facility of the second dimmer channel. In some embodiments, the channel communications connection is also suitable for transmitting information in the opposite direction.

Owing to the fact that a communications connection between each channel control facility of the dimmer channels and a main control facility of the dimmer is already required, e.g. including galvanic separation, it is possible with little additional outlay to receive mutual channel communications connections between the channel control facilities which may even replace a part of the communications connections between the channel control facilities and the main control facility of the dimmer.

The information regarding the periodic behavior of the electrical voltage in a measuring dimmer channel may be a specification regarding the time of the transmission of the information by way of the channel control facility of the first dimmer channel or preferably a specification regarding the time of at least one zero crossing of the voltage in the measuring dimmer channel. On the basis of stored data, it is possible with the aid of the information regarding the periodic behavior of the electrical voltage in the measuring dimmer channel for the channel control facility of the second dimmer channel to produce information regarding the periodic behavior of the electrical voltage in said second dimmer channel and it is possible using said information regarding the periodic behavior of the electrical voltage in said second dimmer channel to accurately and synchronously transmit the electrical voltage in the channel to the remaining dimmer channels.

This stored data may include a time value that is the same as an estimation of the time for the processing and the transmission of the information from the measuring dimmer channel to the control facility of the second dimmer channel. The time value is a constant for each dimmer channel and could contain values regarding the time for producing the information by way of the measuring facility, the transmission of said values by way of the channel communications connection or by way of the channel communications connections from the measuring dimmer channel to the second dimmer channel and the processing of said values in the dimmer channels. It is possible to determine said time value for each dimmer channel, namely from a calibration having measurements at the dimmer or at other dimmers of the same series or in a simulation by means of a computer. In some embodiments, the data is permanently stored in the channel control facilities.

Because the signal is transmitted without complex processing over a short distance, the information regarding the periodic behavior of the electrical voltage in the measuring dimmer channel arrives with a small delay but in particular in the case of repetition and despite aging of the components with an approximately identical delay in the case of the channel control facility of the second dimmer channel. It is worthy of note that this even applies for the entire transmission delay if the signal is transmitted from the original channel control facility of the measuring dimmer channel via some channel control facilities and via the channel communications connections. In some embodiments, the first dimmer channel to a channel communications connection may be a channel other than the measuring dimmer channel.

In some embodiments, the channel communications connection may also at least transmit control commands from the main control facility from the channel control facility of the first dimmer channel to the channel control facility of the second dimmer channel. Consequently, in the same manner the instructions for the switching behavior are also distributed to multiple dimmer channels, which omits direct communications connections to the main control facility of the dimmer. This may also take place for cost reasons in a unidirectional manner although a bidirectional communication brings advantages.

In some embodiments, there is at least one channel communications connection between the channel control facility of the measuring dimmer channel and each channel control facility of at least two dimmer channels. Consequently, the measuring dimmer channel has a direct channel communications connection to multiple control facilities of other dimmer channels. This could be embodied likewise as many individual channel communications connections, or however could also be embodied as one single channel communications connection for a bus communication or similar in accordance with which telegrams are received owing to an individual address or a group address at the destination.

In some embodiments, even the main control facility is a channel control facility.

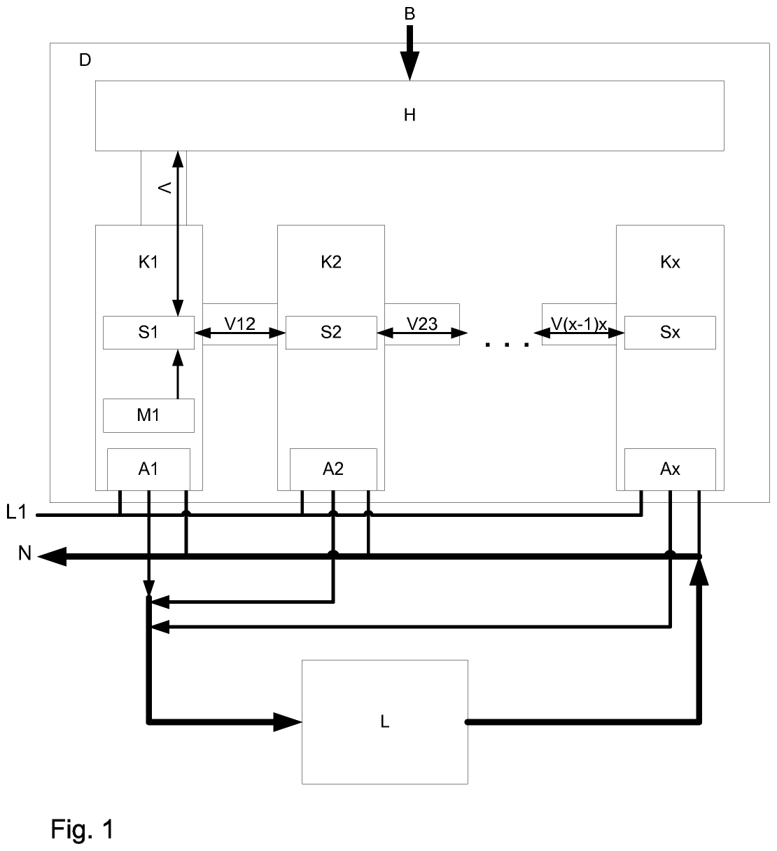

FIG. 1 illustrates the division of functions of a multichannel dimmer D on the supply network N, Ll. The multichannel dimmer D comprises multiple dimmer channels K1, K2, Kx that are galvanically separated from one another, each having a channel control facility S1, S2, Sx. The dimmer channels are connected in parallel on the output side via connecting terminals A1, A2, Ax to the load L so that each may supply a part of the current to said connecting terminals.

The dimmer D starts owing to an external command B. A main control facility H produces control commands, which travel via a communications network V to the channel control facility S1 of the dimmer channel K1.

The dimmer channel K1 includes a measuring facility M1 that is suitable for producing information regarding the behavior of the electrical voltage at a site in the channel and namely in particular information regarding the zero crossing of the voltage. The dimmer channel K1 is therefore also called a measuring dimmer channel. During operation, a communications connection transmits such information from the measuring facility M1 to the channel control facility S1.

Starting from the measuring dimmer channel K1, a channel communications connection V12, V23, V(x−1)x respectively leads from one dimmer channel to the next dimmer channel. In some embodiments, these channel communications connections V12, V23, V(x−1)x are suitable for transmitting information regarding the behavior of the electrical voltage in the measuring dimmer channel K1 to the channel control facility S2, Sx of the next dimmer channel K2, Kx and namely here from the channel control facility S1, S2 of the one dimmer channel K1, K2 to the channel control facility S2, Sx of the other dimmer channel K2, Kx. Furthermore, these channel communications connections V12, V23, V(x−1)x may also relay the control commands of the main control facility H.

The communications connections V, V12, V23, V(x−1)x between the galvanically separated main control facility H and the dimmer channels K1, K2, Kx on both sides each include an optical coupler.

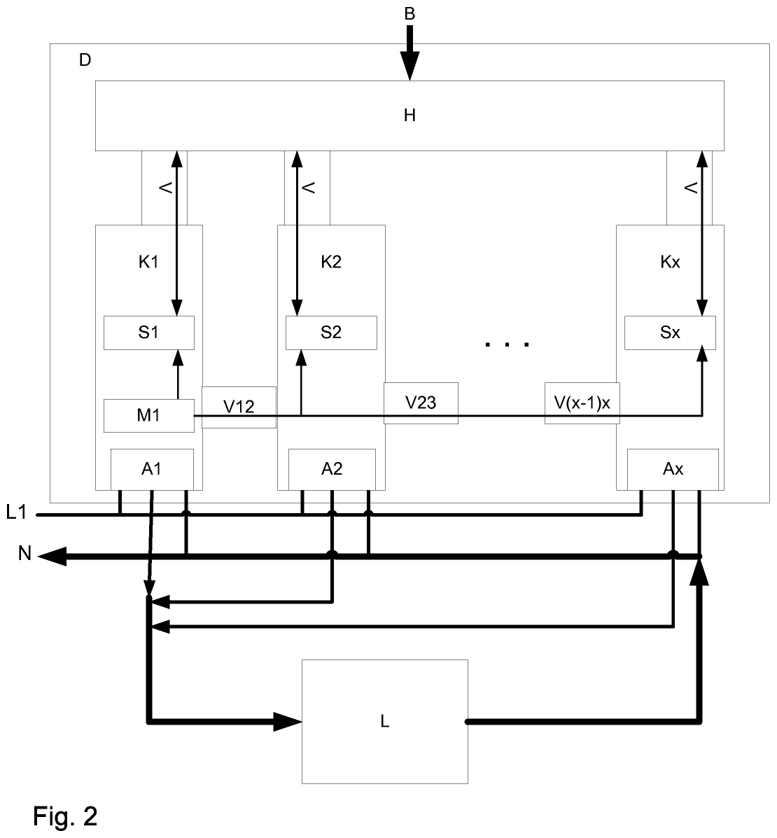

In the variant in FIG. 2, the channel communications connections V12, V23, V(x−1)x between the dimmer channels K1, K2, Kx connect the measuring facility M to the respective channel control facilities S1, S2, Sx for a particularly prompt transmission. The channel communications connections V12, V23, V(x−1)x are embodied in a unidirectional manner, which is why separate communications connections V provide the control commands of the main control facility H to each dimmer channel K1, K2, Kx and return possible feedback.

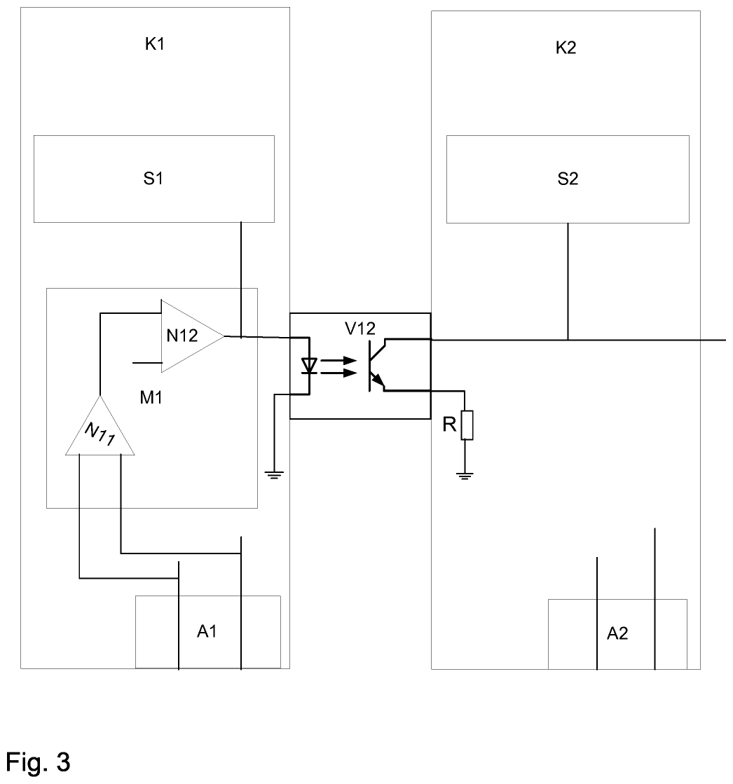

FIG. 3 illustrates measuring dimmer channel K1, dimmer channel K2 and their channel communications connection V12 of a multichannel dimmer incorporating teachings of the present disclosure, wherein the circuits of the measuring facility M, of the channel communications connection V12 and of the dimmer channel K2 are illustrated in a simplified manner. An operation amplifier N11 of the measuring facility M1 converts the network voltage from 230 Volt into a signal that is to be better processed. A comparator N12 of the measuring facility M1 analyzes this signal at zero crossings. The zero crossings are directly relayed to the channel control facility S1 but also to an optical coupler in the channel communications connection V12. For the purpose of galvanic separation, the optical coupler includes an LED and a light-sensitive resistor, which connects a current via the resistor R in the dimmer channel K2. The optical coupler consequently transmits the information regarding the zero crossings with a small delay to the channel control facility S2 and to the next channel communications connection.

In some embodiments, the control commands of the main control facility H travel in a similar manner to that in the variant of FIG. 1 via a single communications connection V to the channel control facility S1 of the dimmer channel K1. However, the channel control facility S1 relays said control commands via the channel communications connections V12 to the next dimmer channel K2 as in the variant of FIG. 2. For this purpose, however, such channel communications connections V12, V23, V(x−1)x that are illustrated in FIG. 3 may be supplemented by way of example with a switch and a resistor upstream of the LED in series with respect to ground. The switch for example a transistor is switched by way of an output of the respective channel control facility Sx between a conductive and non-conductive connection. When the respective comparator Nx2 energizes the LED, the switch may consequently apply small voltage steps onto the signal, which lead to small intensity steps in the light of the LED. The corresponding resistance steps in the light-sensitive resistor on the resistor side may be perceived by a simple voltmeter. However, said resistance steps on the receiver side do not trigger a zero crossing detection. These steps consequently code the control commands of the main control facility H and are relayed by means of the voltmeter to the respective channel facility Sx+1.

What is claimed is:

1. A dimmer for controlling the power consumption of a connectable load, the dimmer comprising:
a first dimmer channel and a second dimmer channel each having an associated channel control facility;
wherein the first dimmer channel includes a measuring dimmer channel with a measuring facility configured for producing information regarding the behavior of the electrical voltage at a site in the measuring dimmer channel;
a main control facility producing control commands for the first dimmer channel and the second dimmer channel;
a communications connection transmitting the control commands from the main control facility to the channel control facility of a dimmer channel; and
a channel communications connection transmitting information from the first dimmer channel to the second dimmer channel;
wherein the channel communications connection transmits information regarding the behavior of the electrical voltage at the site in the measuring dimmer channel.

2. The dimmer as claimed in claim 1, wherein the channel communications connection transmits information to the channel control facility of the second dimmer channel.

3. The dimmer as claimed in claim 1, wherein the information includes a specification regarding the time of a zero crossing of the voltage at the site in the measuring dimmer channel.

4. The dimmer as claimed in claim 1, wherein the channel control facility of the second dimmer channel includes stored data for producing information regarding the behavior of the electrical voltage at a site in the second dimmer channel.

5. The dimmer as claimed in claim 4, wherein the data includes a time value estimating a time for processing and transmitting the information from the measuring dimmer channel to the control facility of the second dimmer channel.

6. The dimmer as claimed in claim 4, wherein the information regarding the behavior of the electrical voltage at the site in the second dimmer channel includes a specification regarding a time of a zero crossing of the voltage.

7. The dimmer as claimed in claim 1, wherein the channel communications connection transmits control commands from the main control facility from the channel control facility of the first dimmer channel to the channel control facility of the second dimmer channel.

8. The dimmer as claimed in claim 1, wherein the channel communications connection comprises an element for galvanically separating the first dimmer channel from the second dimmer channel.

9. The dimmer as claimed in claim 1, wherein the main control facility comprises a channel control facility.

10. The dimmer as claimed in claim 1, wherein the first dimmer channel is not the measuring dimmer channel.

11. The dimmer as claimed in claim 1, wherein at least two channel communications connections each transmit information regarding behavior of the electrical voltage in the measuring dimmer channel from the measuring dimmer channel to at least two other dimmer channels.
